(19) United States
(12) Patent Application Publication
(10) Pub. No.: US 2026/0319494 A1
(43) Pub. Date: Oct. 15, 2026

(54) USE OF LIDAR IN AEROSPACE CRAFT

(71) Applicant: SiLC Technologies, Inc., Monrovia, CA (US)

(72) Inventors: Nirmal Chindhu Warke, Saratoga, CA (US); Vala Fathipour, Pasadena, CA (US); Mehdi Asghari, La Canada Flintridge, CA (US)

(21) Appl. No.: 19/177,516

(22) Filed: Apr. 12, 2025

(51) Int. Cl. G05D 1/242; B64C 29/00; G01S 7/48; G01S 17/58; G05D 109/25

(52) U.S. Cl. CPC G05D 1/242; B64C 29/00; G01S 7/4808; G01S 17/58; G05D 2109/25

(57) ABSTRACT

A Vertical Takeoff and Landing craft (VTOL craft) includes a LIDAR system configured to calculate LIDAR data results for multiple different sample regions. Each of the LIDAR data results indicating the distance and/or radial velocity between the Vertical Takeoff and Landing craft (VTOL craft) and the surface of the ground within one of the sample regions. The Vertical Takeoff and Landing craft (VTOL craft) includes a LIDAR data processor configured to calculate an angular velocity from the LIDAR data results.

### FIELD

The invention relates to optical devices. In particular, the invention relates to LIDAR systems.

### BACKGROUND

A variety of aircraft make use of GPS systems to determine the topography of the land under the aircraft during launch and/or landing for navigation and mapping purposes. However, GPS is not available in a variety of different environments. For instance, GPS is not yet available on other planets or when GPS signals have been jammed. As a result, many aircraft make use of camera LIDAR (Light Detection and Ranging) systems to generate topographical data for the land under the aircraft during launch and/or landing.

LIDAR systems typically output a system output signal that is reflected by an object, such as the ground, located outside of the LIDAR system. At least a portion of the reflected light signal returns to the LIDAR system. The LIDAR system directs the received light signal to a light sensor that converts the light signal to an electrical signal. Electronics can use the light sensor output to quantify LIDAR data that indicates the radial velocity and/or distance between the object and the LIDAR system.

The LIDAR systems used in Vertical Takeoff and Landing craft (VTOL craft), such as helicopters, planetary landers, and drones, often output multiple system output signals in a direction that is fixed relative to the body of the VTOL craft. However, the fixed nature of the system output signals transmitted by these LIDAR systems creates blind spots under the VTOL craft that are not illuminated by the output signals. As a result, these LIDAR systems can miss the presence of objects such as boulders on the ground. Missing an object such as a boulder can damage the VTOL craft during the landing process. As a result, the LIDAR systems used with VTOL craft often provide insufficient information for proper navigation of VTOL craft. Accordingly, there is a need for LIDAR systems that provide more navigation data to VTOL craft.

### SUMMARY

An aerospace craft includes a LIDAR system. The LIDAR system is configured to calculate LIDAR data results for multiple different sample regions. Each of the LIDAR data result indicates a distance and/or radial velocity between the aerospace craft and the surface of the ground in one of the sample regions. The aerospace craft includes a LIDAR data processor configured to calculate an angular velocity from the LIDAR data results. In some instance, the aerospace craft is a Vertical Takeoff and Landing craft (VTOL craft).

A Vertical Takeoff and Landing craft (VTOL craft) includes a LIDAR system. The LIDAR system is configured to output a system output signal that travels away from the LIDAR system. The LIDAR system is configured to scan the system output signal in two dimensions. The LIDAR system is also configured to use a system return signal to calculate a distance and/or radial velocity between the ground and the Vertical Takeoff and Landing craft (VTOL craft). The system return signal includes light from the system output signal that has been reflected by a surface of the ground below the Vertical Takeoff and Landing craft (VTOL craft).

### BRIEF DESCRIPTION OF THE FIGURES

FIG. 1A is a topview of a schematic of a LIDAR system that includes or consists of a LIDAR chip that outputs a LIDAR output signal and receives a LIDAR input signal on a common waveguide.

FIG. 1B is a topview of a schematic of a LIDAR system that includes or consists of a LIDAR chip that outputs a LIDAR output signal and receives a LIDAR input signal on different waveguides.

FIG. 2 is a topview of an example of a LIDAR adapter that is suitable for use with the LIDAR chip of FIG. 1B.

FIG. 3A is a topview of an example of a LIDAR system that includes the LIDAR chip of FIG. 1A and the LIDAR adapter of FIG. 2 on a common support.

FIG. 3B illustrates a LIDAR system that includes system components in addition to the LIDAR adapter of FIG. 3A.

FIG. 3C is a topview of another example of a LIDAR system.

FIG. 3D is a schematic of an optical switch included in a beam scanner or serving as a beam scanner.

FIG. 3E is another schematic of an optical switch included in a beam scanner or serving as a beam scanner.

FIG. 3F illustrates an example of a LIDAR system that combines multiple beam scanners.

FIG. 3G illustrates another example of a LIDAR system that combines multiple beam scanners.

FIG. 4A illustrates a LIDAR system used in a Vertical Takeoff and Landing craft (VTOL craft).

FIG. 4B illustrates another example of a LIDAR system used in a Vertical Takeoff and Landing craft (VTOL craft).

FIG. 5A illustrates an example of a processing component suitable for use with the LIDAR systems.

FIG. 5B provides a schematic of electronics that are suitable for use with a processing component constructed according to FIG. 5A.

FIG. 5C is a graph of a frequency versus time pattern for a system output signal with triangular frequency tuning.

FIG. 6 is a flow diagram illustrating the operations of the LIDAR data generation and LIDAR data processor.

FIG. 7 is a cross-section of a portion of a LIDAR chip that includes a waveguide on a silicon-on-insulator platform.

### DESCRIPTION

An aerospace craft such as a Vertical Takeoff and Landing craft (VTOL craft) has a LIDAR system configured to transmit a system output signal. The LIDAR system scans the system output signal through a series of different sample regions within the field of view of the LIDAR system. The system output signal can be reflected by an object such as the ground. At least a portion of the reflected light signal returns to the LIDAR system. The LIDAR system directs the returned light to a light sensor that converts the returned light to an electrical signal. The LIDAR system includes electronics that use the light sensor output to generate LIDAR data results. Each of the LIDAR data results indicates the radial velocity and/or distance between the LIDAR system and an object within one of the sample regions.

The LIDAR system can be arranged such that the sample regions are beneath the VTOL craft during the landing and/or launching of the VTOL craft. As a result, the system output signal can be incident of the ground and each of the LIDAR data results can indicate the radial velocity and/or distance between the LIDAR system and the ground within one of the sample regions. The LIDAR system can scan the system output signal in two dimensions. As a result, the sample regions can be distributed through an area of the surface of the ground under the VTOL. The ability to distribute the sample regions across an area of the surface of the ground reduces or eliminates blind spots during the landing or launching of a VTOL craft.

A variety of navigation variables can be calculated from systems of equations that are generated from the LIDAR data. For instance, the rate of vertical descent and/or ascent is an important factor in controlling the landing and/or launching of a VTOL craft. However, the rate of vertical descent and/or ascent is a function of the angular velocity of a VTOL craft. The angular velocity of the aircraft can be expressed as a vector for the rate of change in the direction of an axis of the VTOL craft. The angular velocity can be calculated from the LIDAR data and allows the rate of vertical descent and/or ascent to be accurately calculated. Angular velocity is an important navigation variable to track because it allows the orientation of the VTOL craft to be determined and is used in determining the direction in which thrust needs to be applied. As a result, the LIDAR system generates additional data for use in the navigation of the VTOL craft.

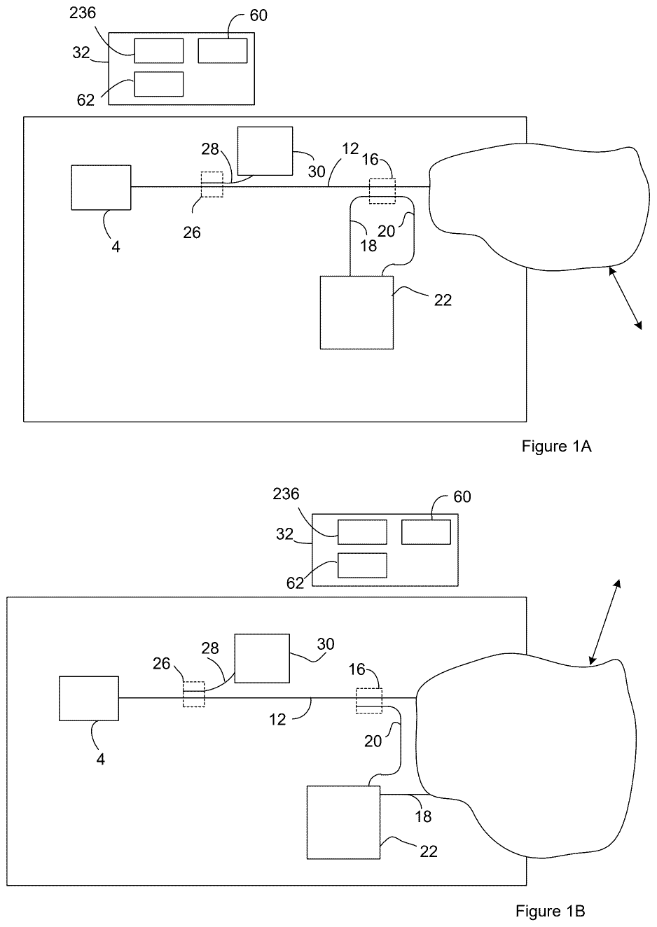

FIG. 1A is a topview of a schematic of a LIDAR chip that can serve as a LIDAR system or can be included in a LIDAR system that includes components in addition to the LIDAR chip. The LIDAR chip can include a Photonic Integrated Circuit (PIC) and can be a Photonic Integrated Circuit chip. The LIDAR chip includes a light source 4 that outputs a preliminary outgoing LIDAR signal. A suitable light source 4 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip includes a utility waveguide 12 that receives an outgoing LIDAR signal from a light source 4. The utility waveguide 12 carries the outgoing LIDAR signal to a signal processor 14. The signal processor 14 can be configured to output a system output signal that serves as the output of the LIDAR system. The system output signal can include, consist of, or consist essentially of light from the outgoing LIDAR signal. The signal processor 14 can be configured to operate on light from the outgoing LIDAR signal so as to shape and/or scan the system output signal. For instance, the signal processor 14 can be configured to operate on light from the outgoing LIDAR signal so as to provide the system output signal with the desired shape and/or such that the system output signal travels away from the LIDAR system in a particular direction. As an example, the signal processor 14 can be configured to operate on light from the outgoing LIDAR signal such that the system output signal is collimated and/or with the desired shape and/or such that the system output signal travels away from the LIDAR system in a particular direction.

The system output signal may be reflected by one or more objects in the path of the system output signal. When the system output signal is reflected, at least a portion of the reflected light can travel back toward the LIDAR system as a system return signal. All or a portion of the system returns signal can be received by the signal processor 14. The signal processor 14 can output an incoming LIDAR signal that includes, consists of, or consists essentially of, light from the system return signal.

The incoming LIDAR signal can enter the utility waveguide 12. The utility waveguide 12 carries the incoming LIDAR signal to a splitter 16 that moves a portion of the outgoing LIDAR signal from the utility waveguide 12 onto a comparative waveguide 18 as a comparative signal. The comparative waveguide 18 carries the comparative signal to a processing component 22 for further processing. Although FIG. 1A illustrates a directional coupler operating as the splitter 16, other signal tapping components can be used as the splitter 16. Suitable splitters 16 include, but are not limited to, directional couplers, optical couplers, y-junctions, tapered couplers, and Multi-Mode Interference (MMI) devices.

The utility waveguide 12 also carries the outgoing LIDAR signal to the splitter 16. The splitter 16 moves a portion of the outgoing LIDAR signal from the utility waveguide 12 onto a reference waveguide 20 as a reference signal. The reference waveguide 20 carries the reference signal to the processing component 22 for further processing.

The percentage of light transferred from the utility waveguide 12 by the splitter 16 can be fixed or substantially fixed. For instance, the splitter 16 can be configured such that the power of the reference signal transferred to the reference waveguide 20 is an outgoing percentage of the power of the outgoing LIDAR signal or such that the power of the comparative signal transferred to the comparative waveguide 18 is an incoming percentage of the power of the incoming LIDAR signal. In many splitters 16, such as directional couplers and multimode interferometers (MMIs), the outgoing percentage is equal or substantially equal to the incoming percentage. In some instances, the outgoing percentage is greater than 30%, 40%, or 49% and/or less than 51%, 60%, or 70% and/or the incoming percentage is greater than 30%, 40%, or 49% and/or less than 51%, 60%, or 70%. A splitter 16, such as a multimode interferometer (MMI), generally provides an outgoing percentage and an incoming percentage of 50% or about 50%. However, multimode interferometers (MMIs) can be easier to fabricate in platforms such as silicon-on-insulator platforms than some alternatives. In one example, the splitter 16 is a multimode interferometer (MMI) and the outgoing percentage and the incoming percentage are 50% or substantially 50%. As will be described in more detail below, the processing component 22 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a control branch for controlling the operation of the light source 4. The control branch includes a splitter 26 that moves a portion of the outgoing LIDAR signal from the utility waveguide 12 onto a control waveguide 28. The coupled portion of the outgoing LIDAR signal serves as a tapped signal. Although FIG. 1A illustrates a directional coupler operating as the splitter 26, other signal tapping components can be used as the splitter 26. Suitable splitters 26 include, but are not limited to, directional couplers, optical couplers, y-junctions, tapered couplers, and Multi-Mode Interference (MMI) devices.

The control waveguide 28 carries the tapped signal to control components 30. The control components 30 can be in electrical communication with electronics 32. All or a portion of the control components 30 can be included in the electronics 32. During operation, the electronics can employ output from the control components 30 in a feedback loop 34 configured to control a frequency versus time pattern of a controlled light signal such as the tapped signal, the outgoing LIDAR signal, the LIDAR output signal and/or the system output signal.

The control waveguide 28 carries the control signal to a feedback system 30. The feedback system 30 can include one or more light sensors (not shown) that convert the control signals to electrical signals that are output from the feedback system 30. The electronics 32 can include a light source controller 62 configured to receive the electrical signals output from the feedback system 30. During operation, the light source controller 62 can adjust the frequency of the outgoing LIDAR signals in response to output from the electrical signals output from the feedback system 30. For instance, the light source controller 62 can adjust the frequency of the outgoing LIDAR signals so as to provide the outgoing LIDAR signals, and the resulting light signals, with the desired frequency versus time pattern. An example of a suitable construction and operation of feedback system 30 and light source controller 62 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although the light source 4 is shown as being positioned on the LIDAR chip, the light source 4 can be located off the LIDAR chip. For instance, the utility waveguide 12 can terminate at a second facet through which the outgoing LIDAR signal can enter the utility waveguide 12 from a light source 4 located off the LIDAR chip.

The LIDAR system can be modified so the incoming LIDAR signal and the outgoing LIDAR signal travel different optical pathways through the LIDAR chip. For instance, the incoming LIDAR signal and the outgoing LIDAR signal can be carried on different waveguides on the LIDAR chip. For instance, FIG. 1B is a topview of the LIDAR chip of FIG. 1A modified such that the incoming LIDAR signal and the outgoing LIDAR signal are carried on different waveguides. The comparative waveguide 18 is positioned on the LIDAR chip such that the incoming LIDAR signal output by the signal processor 14 is received by the comparative waveguide 18 rather than the utility waveguide 12. The portion of the incoming LIDAR signal carried by the comparative waveguide 18 can serve as the comparative signal. The comparative waveguide 18 carries the comparative signal to a processing component 22 for further processing. As described in the context of FIG. 1A, the reference waveguide 20 carries the reference signal to the processing component 22 for further processing. As will be described in more detail below, the processing component 22 combines the comparative signal with the reference signal to form a composite signal that carries LIDAR data for a sample region on the field of view.

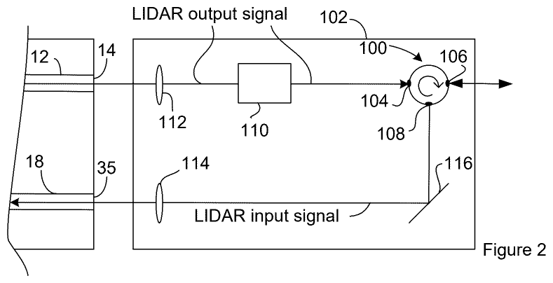

In some instances, the signal processor 14 includes a LIDAR adapter. For instance, a LIDAR chip constructed according to FIG. 1B can have a signal processor 14 that includes a LIDAR adapter. An example of a LIDAR adapter that is suitable for use with the LIDAR chip of FIG. 1B is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108.

The utility waveguide 12 terminates at a facet 14 and carries the outgoing LIDAR signal to the facet 14. The facet 14 can be positioned such that the outgoing LIDAR signal traveling through the facet 14 exits the LIDAR chip and serves as a LIDAR output signal. For instance, the facet 14 can be positioned at an edge of the chip so the outgoing LIDAR signal traveling through the facet 14 exits the chip and serves as the LIDAR output signal. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter. The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

Light from the system output signal output by the LIDAR system can include, consist of, or consist essentially of, light from the LIDAR output signal output from the LIDAR adapter. When one or more objects in a sample region reflect the system output signal, at least a portion of the reflected light can travel back to the circulator 100 as a system return signal. The system return signal enters the circulator 100 through the second port 106. FIG. 2 illustrates the LIDAR output signal and the system return signal traveling between the LIDAR adapter and a sample region along the same optical path.

The system return signal exits the circulator 100 through the third port 108 and is directed to the comparative waveguide 18 on the LIDAR chip. Accordingly, all or a portion of the system return signal can serve as a LIDAR input signal output from the LIDAR adapter. The LIDAR input signal can include, consist of, or consist essentially of, light from the system return signal. The LIDAR input signal can enter the comparative waveguide 18 through a facet. The portion of the LIDAR input signal that enters the utility waveguide 12 serves as the incoming LIDAR signal. Accordingly, the incoming LIDAR signal can include, consist of, or consist essentially of, light from the LIDAR input signal. The incoming LIDAR signal can include, consist of, or consist essentially of, light from the system return signal. The LIDAR output signal and the LIDAR input signal travel between the LIDAR adapter and the LIDAR chip along different optical paths.

As is evident from FIG. 2, the LIDAR adapter can include optical components in addition to the circulator 100. For instance, the LIDAR adapter can include components for directing and controlling the optical path of the LIDAR output signal and the system return signal. As an example, the adapter of FIG. 2 includes an optional amplifier 110 positioned so as to receive and amplify the LIDAR output signal before the LIDAR output signal enters the circulator 100. The amplifier 110 can be operated by the electronics 32 allowing the electronics 32 to control the power of the LIDAR output signal.

FIG. 2 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal to the facet 35 of the comparative waveguide 18.

The LIDAR adapter can also include one or more direction changing components such as mirrors. FIG. 2 illustrates the LIDAR adapter including a mirror as a direction-changing component 116 that redirects the system return signal from the circulator 100 to the facet 20 of the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, the system return signal and/or the LIDAR output signal can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers, and the remaining components are discrete components.

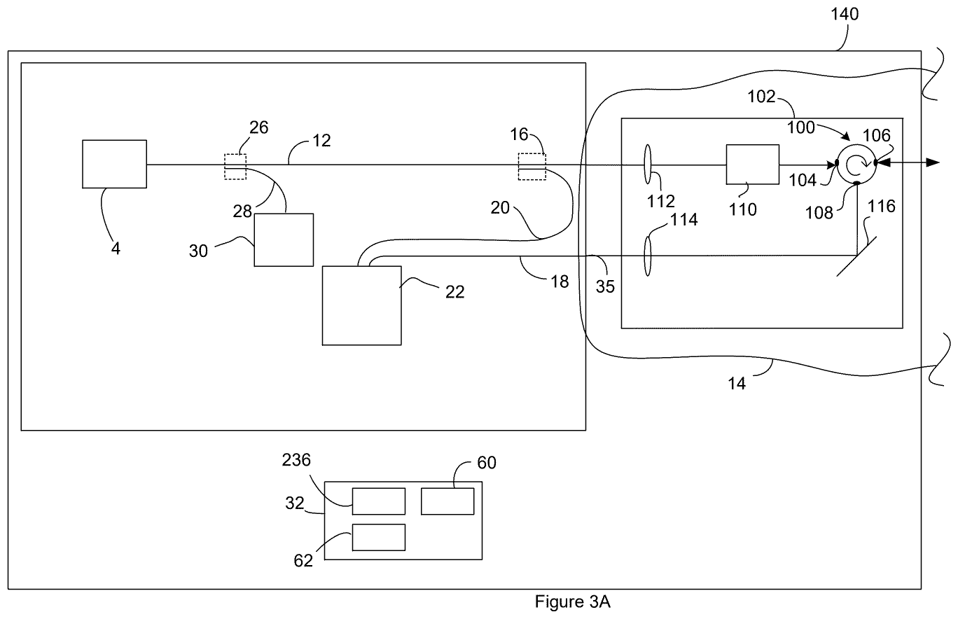

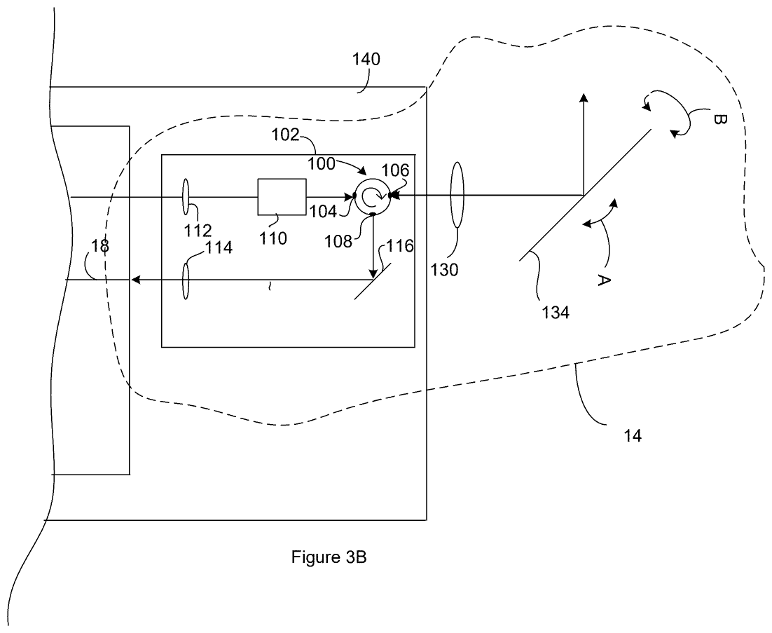

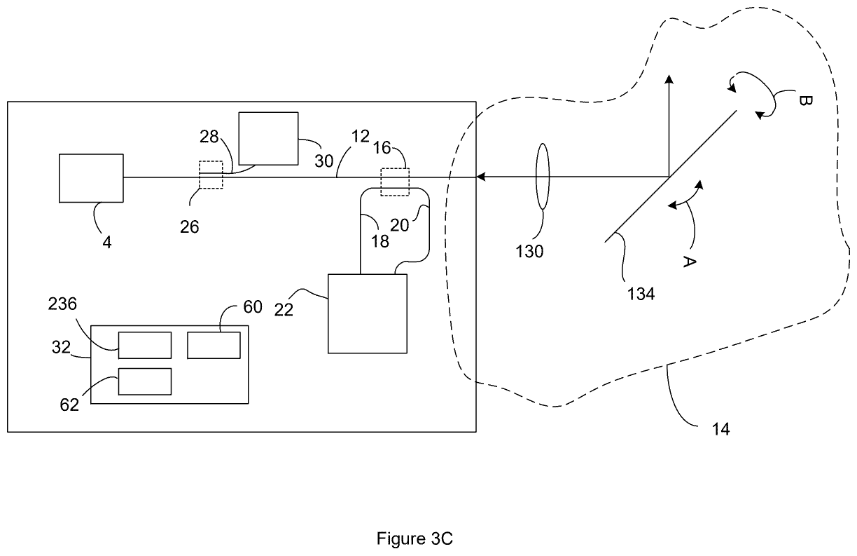

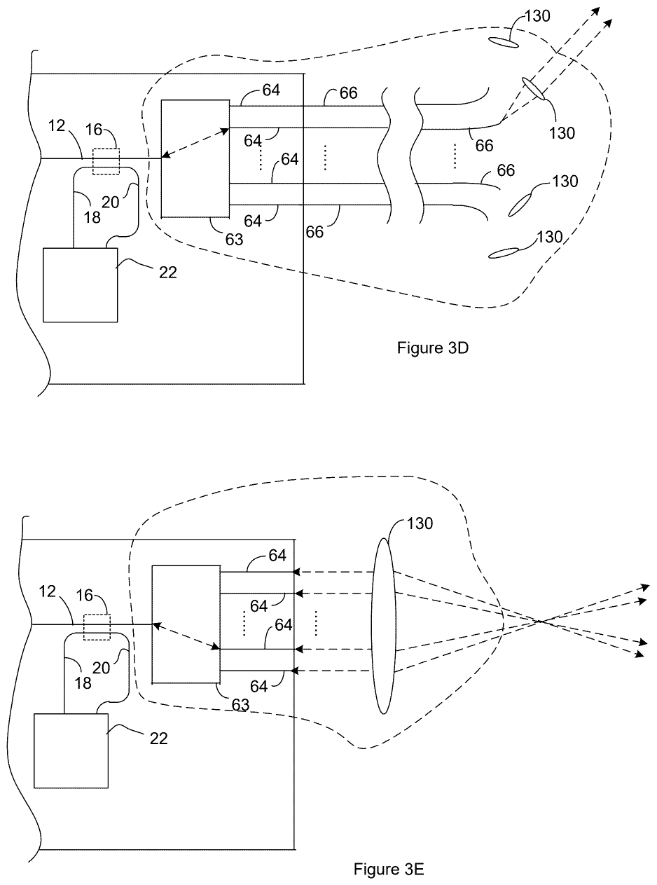

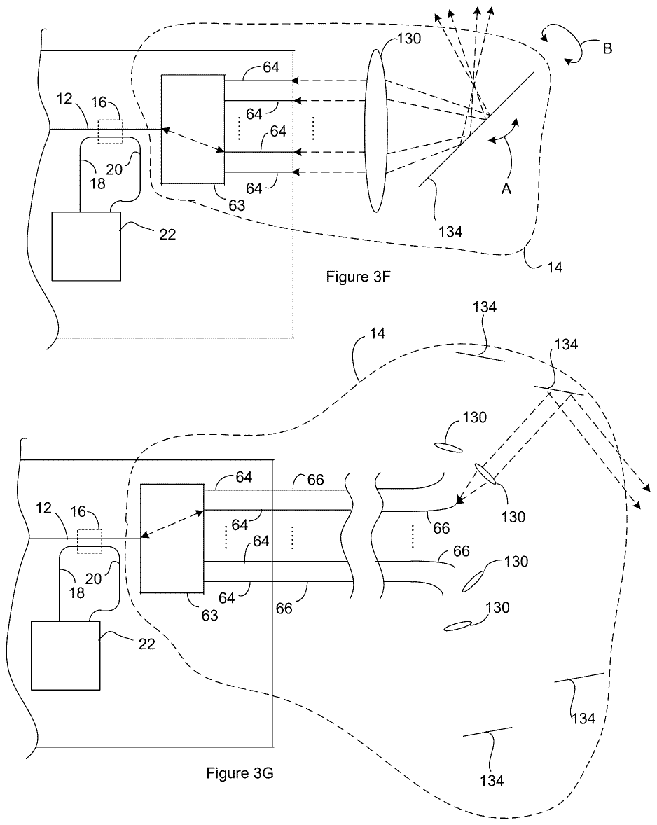

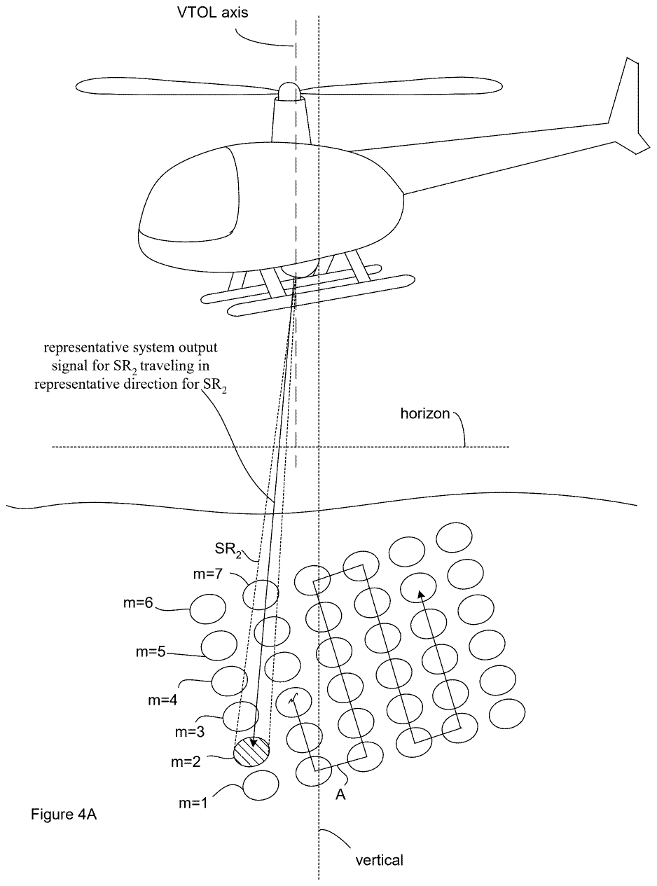

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 3A is a topview of a LIDAR system that includes the LIDAR chip and electronics 32 of FIG. 1A and the LIDAR adapter of FIG. 2 on a common support 140. Although the electronics 32 are illustrated as being located on the common support, all or a portion of the electronics can be located off the common support. When the light source 4 is located off the LIDAR chip, the light source can be located on the common support 140 or off of the common support 140. Suitable approaches for mounting the LIDAR chip, electronics, and/or the LIDAR adapter on the common support include, but are not limited to, epoxy, solder, and mechanical clamping.

A signal processor 14 can include system components in addition to a LIDAR adapter or as an alternative to a LIDAR adapter. Examples of suitable system components include, but are not limited to, optical switches, optical links, beam shapers, polarization state rotators, beam scanners, optical splitters, optical amplifiers, and optical attenuators. FIG. 3B illustrates a LIDAR system that includes system components in addition to the LIDAR adapter of FIG. 3A. The LIDAR system of FIG. 3B includes one or more beam shapers 130 that receive the LIDAR output signal from the adapter and output a shaped LIDAR output signal. The one or more beam shapers 130 can be configured to provide the shaped LIDAR output signal with the desired shape. For instance, the one or more beam shapers 130 can be configured to output a LIDAR output signal shaped so as to be focused, diverging or collimated. In FIG. 3B, the one or more beam shapers 130 is a lens that is configured to output a collimated LIDAR output signal.

The LIDAR systems of FIG. 3B can optionally include one or more beam scanners 134 that receive the shaped LIDAR output signal from the one or more beam shapers 130. The portion of the LIDAR output signal that exits the LIDAR system serves as the system output signal. As a result, in the version of the LIDAR system illustrated in FIG. 3B, the portion of the LIDAR output signal output from the one or more beam scanners 134 serves as the system output signal. Suitable beam scanners include, but are not limited to, movable mirrors, MEMS mirrors, optical phased arrays (OPAs), optical gratings, actuated optical gratings and actuators that move the LIDAR chip, LIDAR adapter, and/or common mount 128.

When the system output signal is reflected by an object located outside of the LIDAR system, at least a portion of the reflected light returns to the LIDAR system as a system return signal. In the LIDAR system of FIG. 3B, the one or more beam scanners 134 receive the system return signal and output the system return signal. The one or more beam shapers 130 receive the system return signal from the one or more beam scanners 134 and output a shaped system return signal that can serve as the LIDAR input signal received by the LIDAR adapter.

Although FIG. 3B illustrates the one or more beam scanners 134 and one or more beam shapers 130 used in conjunction with a LIDAR adapter, the one or more beam scanners 134 and one or more beam shapers 130 can be used in conjunction with a LIDAR chip constructed according to FIG. 1A. For instance, a LIDAR chip constructed according to FIG. 1A can be used with a signal processor 14 that includes one or more beam scanners 134 and one or more beam shapers 130. As an example, the LIDAR system of FIG. 3C includes a beam shaper 130 that receives the LIDAR output signal output from the LIDAR chip and outputs a shaped LIDAR output signal. The one or more beam shapers 130 can be configured to provide the shaped LIDAR output signal with the desired shape. For instance, the one or more beam shapers 130 can be configured to output a LIDAR output signal shaped so as to be focused, diverging or collimated. In FIG. 3C, the one or more beam shapers 130 is a lens that is configured to output a collimated LIDAR output signal.

The LIDAR systems of FIG. 3C includes a beam scanner 134 that receives the shaped LIDAR output signal from the beam shaper 130. The portion of the LIDAR output signal that exits the LIDAR system serves as the system output signal. As a result, in the version of the LIDAR system illustrated in FIG. 3C, the portion of the LIDAR output signal output from the beam scanner 134 serves as the system output signal. Suitable beam scanners include, but are not limited to, movable mirrors, MEMS mirrors, optical phased arrays (OPAs), optical gratings, actuated optical gratings and actuators that move the LIDAR chip, LIDAR adapter, and/or common mount 128.

When the system output signal is reflected by an object located outside of the LIDAR system, at least a portion of the reflected light returns to the LIDAR system as a system return signal. In the LIDAR system of FIG. 3C, the beam scanner 134 receives the system return signal and outputs the system return signal. The beam shaper 130 receives the system return signal from the beam scanner 134 and outputs a shaped system return signal that can serve as the LIDAR input signal received by the LIDAR chip.

The one or more beam scanners 134 can be operated so as to scan the system output signals within the LIDAR system's field of view. For instance, the one or more beam scanners 134 can be operated so as to change the direction that the system output signal travels away from the LIDAR system.

The signal processors can include an optical switch that can serve as a beam scanner. FIG. 3D provides an example of a signal processor 14 that includes an optical switch 63 that serves as a beam scanner. The optical switch 63 receives the outgoing LIDAR signal from the utility waveguide 12. The LIDAR chip includes multiple different alternate waveguides 64. The optical switch 63 is configured to direct the outgoing LIDAR signal to any one of the alternate waveguides 64. For instance, the electronics 56 can include a scan controller 60 configured to operate the optical switch so as to select which one of the alternate waveguides 64 receives the outgoing LIDAR signal from the optical switch. The scan controller 60 can change the alternate waveguide 64 that is selected to receive the outgoing LIDAR signal from the optical switch 63.

Each of the alternate waveguides 64 terminates at a facet and carries the outgoing LIDAR signal to the facet. The facet can be positioned such that the outgoing LIDAR signal traveling through the facet exits the LIDAR chip and serves as a LIDAR output signal. Accordingly, the optical switch 63 can be operated such that the optical switch 63 selects which one of the alternate waveguides 64 outputs the LIDAR output signal from the LIDAR chip. The LIDAR system includes optical links 66 that each received the LIDAR output signal from a different one of the alternate waveguides. Accordingly, the optical switch 63 can be operated so as to select which one of the optical links 66 receives the LIDAR output signal from the LIDAR chip.

The LIDAR system includes beam shapers 130. Each of the beam shapers is positioned to receive the LIDAR output signal from a different one of the optical links 66 and to output a shaped LIDAR output signal. The beam shapers 130 can be configured to provide the shaped LIDAR output signal with the desired shape. For instance, the one or more beam shapers 130 can be configured to output a LIDAR output signal shaped that is focused, diverging or collimated. In FIG. 3D, each of the beam shapers 130 is a lens that is configured to output a collimated LIDAR output signal. The portion of the shaped LIDAR output signal that exits the LIDAR system serves as the system output signal.

The optical links 66 and beam shapers 130 are configured such that the system output signal travels away from the LIDAR system in different directions when the system output signal is output from different beam shapers 130. Since the optical switch 63 can be operated so as to select which one of the beam shapers 130 outputs the system output signal, the optical switch 63 can be operated so as to select the direction the system output signal travels away from the LIDAR system. Accordingly, the optical switch 63 can serve as a beam scanner.

A suitable number of alternate waveguides 64 for use in the signal processor 14 (N) includes but is not limited to values greater than or equal to 2, 4, or 6 and less than or equal to 8, 16, or 32. A suitable optical switch 63 includes, but is not limited to, SOA arrays, cascaded Mach-Zehnder Interferometer (MZI) switches, and a 1×N splitter an array of attenuators. Suitable optical links include, but are not limited to, fiber optics.

The signal processor 14 of FIG. 3D can include additional components. Additionally, or alternately, all or a portion of the components in the signal processor 14 of FIG. 3D can be arranged in other configurations and/or can be excluded from the signal processor 14. As an example, FIG. 3E illustrates the signal processor 14 of FIG. 3D adapted to exclude the optical links. The LIDAR system includes a beam shaper 130 that receives the LIDAR output signal from multiple different alternate waveguides.

The beam shaper 130 can be configured to output shaped LIDAR output signals. The beam shaper 130 can be configured to output the shaped LIDAR output signals with the desired shape. For instance, the one or more beam shapers 130 can be configured to output a LIDAR output signals with a shape that is focused, diverging or collimated. In FIG. 3E, the beam shaper 130 is a lens that is configured to output a collimated LIDAR output signal. The portion of the shaped LIDAR output signal that exits the LIDAR system serves as the system output signal.

The beam shaper 130 can receive the LIDAR output signal from all, or a portion, of the alternate waveguides 64. Although the LIDAR output signal is illustrated traveling between the LIDAR chip and the beam shaper 130 through free space; all, or a portion, of the optical pathways that the LIDAR input signals travel between LIDAR chip and the beam shaper 130 can optionally include an optical link. The LIDAR chip and beam shaper 130 are configured such that LIDAR output signals from different alternate waveguides 64 have different angles of incidence of the beam shaper 130. For instance, the alternate waveguides 64 and the beam shaper 130 can be configured such that LIDAR output signals from different alternate waveguides 64 have different angles of incidence of the beam shaper 130. As a result of the different angles of incidence, LIDAR output signals from different alternate waveguides 64 are the source of system output signals that travel away from the LIDAR system in different directions. Since the optical switch 63 can be operated so as to select which of the alternate waveguides 64 receives the LIDAR output signal, the optical switch 63 can be operated so as to select the direction the system output signal travels away from the LIDAR system. Accordingly, the optical switch 63 can serve as a beam scanner.

FIG. 3F illustrates the signal processor of FIG. 3E adapted such that a beam scanner 134 receives all, or a portion, of the shaped LIDAR output signal from the beam shaper 130. The portion of the LIDAR output signal that is output from the beam scanner 134 and that exits the LIDAR system serves as the system output signal. The beam scanner 134 can be operated so as to steer the direction that the system output signals travel away from the LIDAR system. The scan controller 60 can operate the beam scanner so as to steer the direction that the system output signal travels away from the LIDAR system. As a result, the scan controller 60 can operate the optical switch 63 and/or the beam scanner 134 so as to change the direction that the system output signal travels away from the LIDAR system.

FIG. 3G illustrates the signal processor of FIG. 3D adapted to includes multiple beam scanners 134. Each of the beam scanners 134 receives the shaped LIDAR output signal from a different one of the beam shapers 130. The portion of the LIDAR output signal that is output from one of the beam scanners 134 and that exits the LIDAR system serves as the system output signal. The beam scanners 134 can each be operated so as to steer the direction that the system output signals travel away from the LIDAR system. The scan controller 60 can operate each of the beam scanners so as to steer the direction that the system output signal travels away from the LIDAR system. For instance, the scan controller 60 can operate the optical switch 63 and/or the beam scanners 134 so as to change the direction that the system output signal travels away from the LIDAR system.

As noted above, the electronics 32 can include a scan controller 60 that operates each of the beam scanners so as to steer the direction that the system output signal travels away from the LIDAR system. For instance, when one or more of the beam scanners is a movable mirror, the movable mirror can be moved as illustrated by the arrow label A and/or B in FIG. 3B, FIG. 3C, and FIG. 3F. As a result, the scan controller 60 can operate a beam scanner 134 so as to scan the system output signal in one dimension or in two dimensions. Although not illustrated by arrows, the scan controller 60 can operate the beam scanners 134 shown in FIG. 3G so as to scan the system output signal in one dimension or in two dimensions.

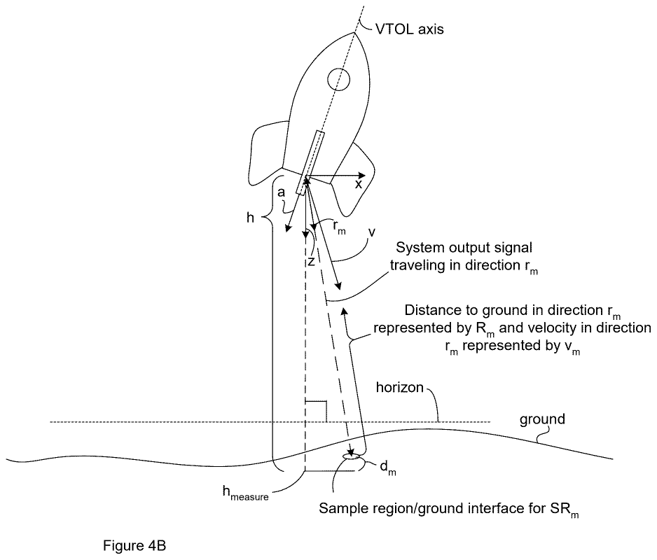

The scan controller 60 can operate the one or more beam scanners so as to steer the system output signal to a series of different sample regions within the field of view of the LIDAR system. FIG. 4A illustrates the LIDAR system used in a Vertical Takeoff and Landing craft (VTOL craft). In particular, FIG. 4A illustrates the LIDAR system used with a helicopter. The VTOL craft includes a housing 70 that is transparent, or substantially transparent to the system output signals and the system return signals. As a result, when a housing 70 is present, the system output signal and/or system return signals can be transmitted through the housing 70.

The region of space labeled SR₂ in FIG. 4A represents an example of a sample region illuminated by a system output signal. The sample regions can each be associated with a different sample region index m and represented by SRₘ. Accordingly, the sample region labeled SR₂ represents the sample region associated with sample region index m=2. An arrow illustrating a ray of the system output signal can represent the central ray of the system output signal during the illumination of the sample region SRₘ and/or can represent the centroid of the sample region SRₘ. Accordingly, the direction of the arrow illustrating the representative ray of the system output signal can serve as a representative direction for the sample region SRₘ and/or can represent the direction of the sample region associated with sample region index m.

Each of the sample regions can extend away from the LIDAR system to a maximum operational distance for which the LIDAR system is configured to provide reliable LIDAR data. The sample regions can be stitched together to define the field of view. For instance, the field of view for the LIDAR system is defined by the perimeter of the group of sample regions. As a result, the sample regions can serve as three dimensional pixels that define the field of view for the LIDAR system.

Although the sample regions can extend to the maximum operational distance, FIG. 4A illustrates the ground at a distance less than the maximum operational distance from the VTOL craft. As a result, the system output signal is incident on the ground before reaching the maximum operational distance. Accordingly, the sample regions are incident on the ground before reaching the maximum operational distance. The intersection between each of the sample regions and the ground is illustrated by an oval shape on the ground although other shapes are possible depending on the scan of the system output signal, the direction of the system output signal, the topography on the ground and the shape of the system output signal. The intersection between each of the sample regions and the surface of the ground can serve as a sample region/ground interface.

As noted above, the scan controller 60 steers the system output signal to a series of different sample regions within the field of view of the LIDAR system. Since the scan controller 60 can steer the system output signal in two dimensions, the sample regions/ground interfaces can be located throughout an area on the surface of the ground. As an example, the arrow labeled A in FIG. 4A is an example of a pattern through which the system output signal can be scanned (scan pattern) so as to provide the sample region/ground interface pattern (interface pattern) where the sample regions/ground interfaces are spread throughout an area of the surface of the ground. Since the sample region/ground interfaces are spread throughout an area of the ground surface, the representative rays for the different sample regions intersect the surface of the ground throughout an area of the ground surface. Accordingly, the locations where the representative rays for the sample regions at the perimeter of the interface pattern intersect the ground surface define an area of the ground surface.

Although the interface pattern in FIG. 4A is shown as a grid pattern, other scan patterns can be used and can produce other interface patterns. For instance, the system output signal can be scanned in a zig-zag pattern that would produce a zig-zag interface pattern on ground that is flat and horizontal. Other examples include, but are not limited to, scanning in a scan pattern that produces an interface pattern that is a random pattern, or a lissajous pattern, on ground that is flat and horizontal. Although FIG. 4A illustrates the sample regions as being spaced apart from one another, the sample regions can overlap with one another.

The ability of the system output signal to be scanned in two dimensions allows an interface pattern to be achieved without lateral movement of the VTOL craft. For instance, the interface pattern of FIG. 4A can be achieved without lateral movement of the VTOL craft. As a result, an interface pattern can be achieved while the VTOL craft remains stationary, or substantially stationary, relative to earth. Further, an interface pattern can be achieved while the VTOL craft moves vertically relative to earth without lateral movement relative to earth. As a result, since the field of view for the LIDAR system can be scanned multiple times during the vertical descent and/or ascent of a VTOL craft, a system output signal can be scanned through an interface pattern multiple times during the vertical descent and/or ascent of a VTOL craft.

The system output signal can be scanned such that the interface pattern is beneath the VTOL craft. In some instances, the system output signal is scanned such that the sample region/ground interface for at least a portion of the sample regions is directly beneath the VTOL craft. For instance, the system output signal can be scanned such that the sample region/ground interface for at least a portion of the sample regions is between the VTOL craft and the ground. As another example, the system output signal can be scanned such that a vertical line (labeled “vertical” in FIG. 4A) this is perpendicular to the horizon (labeled “horizon” in FIG. 4A) can pass through the VTOL craft and all, or a portion, of the sample region/ground interfaces in the interface pattern.

The electronics include a data processor (not shown) configured to generate LIDAR data for the sample regions. The LIDAR data for each sample region indicates the distance and/or radial velocity between the LIDAR system and of an object in the sample region. In the case of FIG. 4A, the object is the surface of the ground. The distance between the LIDAR system and the ground in sample region m can be represented by Rₘ. The radial velocity between the LIDAR system can be represented by vₘ. The sample regions can be stitched together to define the field of view of the LIDAR system. For instance, the field of view of for the LIDAR system includes or consists of the space occupied by the combination of the sample regions. As a result, the sample regions can serve as three dimensional pixels. The distances and/or radial velocities and relative locations of the different sample regions can be used to determine the topography of the portion of the ground illuminated by the interface pattern.

The position of the interface pattern beneath the VTOL craft allows the LIDAR data to be generated for the portion of the ground under the VTOL craft. Further, the multi-dimensional nature of the interface pattern allows the LIDAR data to be generated for the area of the ground under the VTOL craft. Additionally, multiple scans of the field of view can be performed during the takeoff and/or landing of a VTOL craft. For instance, the system output signal can be scanned over a series of the interface patterns during the takeoff and/or landing of a VTOL craft. The LIDAR data can be generated for the sample region/ground interfaces in the different interface patterns. As a result, the topography of the ground under the VTOL craft is known during the takeoff and/or landing of the VTOL craft.

Although FIG. 4A illustrates the VTOL craft as a helicopter, the LIDAR system can be used with other VTOL craft such as rockets, drones, lunar landers, and planetary landers. Accordingly, suitable VTOL craft include, but are not limited to, VTOL aircraft, and VTOL spacecraft.

FIG. 4B illustrates the LIDAR system used with a rocket that serves as the VTOL craft. A Cartesian coordinate system is illustrated in FIG. 4B; however, other coordinate systems can be used. The unit vectors showing the x and z directions of the coordinate system are respectively labeled \vec{x} and \vec{z} in FIG. 4B. The unit vector for the y direction extends out of the page. In FIG. 4B, the unit vector for the z direction is selected to be perpendicular to the horizon although other selections can be used. Accordingly, the unit vector for the z direction is vertical relative to the horizon.

FIG. 4A and FIG. 4B each illustrate the VTOL craft having a VTOL axis. In some instances, the VTOL axis can be defined such that when the VTOL craft has landed on a surface that is flat and horizontal, the VTOL axis is perpendicular to the surface and extends through the VTOL craft, however, other selections of the VTOL axis are possible. In FIG. 4B, the VTOL axis is defined such that when the VTOL craft has landed on a surface that is flat and horizontal, the VTOL axis is perpendicular to the surface. A unit vector representing the direction of the VTOL axis is labeled \vec{a}.

FIG. 4B includes an arrow illustrating a system output signal illuminating the sample region associated with sample region index m. The sample region associated with sample region index m is represented by SRₘ. An arrow illustrating a ray of the system output signal can represent the central ray of the system output signal during the illumination of the sample region SRₘ and/or can represent the centroid of the sample region SRₘ. Accordingly, the arrow illustrating the ray of the system output signal can serve as a representative direction for the sample region SRₘ and/or can represent the direction of the sample regions associated with sample region index m. A unit vector representing the direction of the representative direction for sample region SRₘ is labeled \vec{r}ₘ. Since different sample regions in a scan pattern can have different directions, each of the sample regions can be associated with a different representative direction represented by unit vector \vec{r}ₘ. The distance between the LIDAR system and the ground for in the direction \vec{r}ₘ can be represented by Rₘ. The velocity of the VTOL craft in the direction \vec{r}ₘ can be the radial velocity for sample region SRₘ and can be represented by vₘ.

The distance of the VTOL craft from the ground in the direction of the unit vector \vec{z} is labeled h in FIG. 4B. The location on the ground where h is measured is labeled hₘₑₐₛᵤᵣₑ. As is evident from FIG. 4B, the elevation of the hₘₑₐₛᵤᵣₑ can be different from the elevation of the sample region/ground interface for SRₘ. In FIG. 4B, the additional distance that a system output signal traveling the representative direction \vec{r}ₘ would need to travel to reach the elevation of hₘₑₐₛᵤᵣₑ is labeled dₘ. In some instances, hₘₑₐₛᵤᵣₑ is at a higher elevation than the elevation of the sample region/ground interface for SRₘ. As a result, dₘ can represent the difference between Rₘ and the distance that the system output signal travels in the representative direction \vec{r}ₘ before reaching the elevation at hₘₑₐₛᵤᵣₑ. A value of dₘ can be associated with each of the sample regions SRₘ.

A vector representing the velocity of the VTOL craft is labeled \vec{v} and is an unknown variable. The velocity of the VTOL craft in the direction \vec{r}ₘ is the radial velocity and can be expressed as vₘ=\vec{v}·\vec{r}ₘ where · represents a dot product. The distance of the VTOL craft from the ground in the direction of the unit vector \vec{z} (h) can be expressed as h=(Rₘ+dₘ)(\vec{r}ₘ·\vec{z}).

The representative direction for each sample region (\vec{r}ₘ) is measured relative to the coordinate system and accordingly can be considered an absolute direction that is an unknown variable. However, the representative directions (\vec{r}ₘ) relative to the VTOL axis are known parameters. Accordingly, the direction of the system output signals relative to \vec{a} is a known parameter. As a result, each of the vectors \vec{r}ₘ can be written as \vec{r}ₘ=\vec{ra}ₘ+\vec{a} where \vec{ra}ₘ represents the direction of the system output signals relative to the VTOL axis rather than the coordinate system. The variable \vec{ra}ₘ can also represent the direction of sample regions SRₘ relative to the VTOL axis. With these values, vₘ can be expressed as vₘ=v·(\vec{ra}ₘ+å) and h can be expressed as h=(Rₘ+dₘ)*(\vec{ra}ₘ+\vec{a})·\vec{z}. In these equations, the values of Rₘ and vₘ are variables for each of the sample regions since these values can change in response to each scan of the system output signal in the field of view. For instance, the values of Rₘ and vₘ for different sample regions can be previously calculated by a LIDAR data generator as described below. Since the contents of the LIDAR system field of view can change or stay the same with each scan of the system output signal within the field of view; all, none, or a portion of the values of Rₘ and vₘ calculated from each scan can change. Accordingly, Rₘ and vₘ can serve as known variables where the value of these variables is known for the purposes of the above equations for h and vₘ. The vector \vec{z} is also a known parameter as it is perpendicular to the horizon. Accordingly, the values of \vec{a}, \vec{v}, h, and dₘ are unknown variables, the value of \vec{z} and \vec{ra}ₘ are known parameters and Rₘ and vₘ are variable with known values (known variables). In a cartesian coordinate system, each of the vectors \vec{a} and \vec{v} has three unknown variables that are each associated with one of the coordinates x, y, and z.

Multiple different sample regions can be used to generate a first system of equations. The sample regions used to generate the first system of equations can be a first selection of the sample regions and can include N different sample regions where N is an integer greater than 1. For instance, the N different sample regions in the first selection of sample regions can be used in the first system of equations. Accordingly, N different values of m can be used with the equations vₘ=\vec{v}·(\vec{ra}ₘ+\vec{a}) and h=(Rₘ+dₘ)*(\vec{ra}ₐₘ+\vec{a})·\vec{z}. Since two equations can result from each value of m, there can be up to 2N equations generated for N different sample regions. The values of \vec{a}, \vec{v}, and h remains the same for each value of m while the value of dₘ can be different for each value of m. As a result, in a first system of equations developed from N sample regions, the equations for vₘ and h for each one of the N different values from m provide 7+N unknown variables. Accordingly, the LIDAR data processor can use the LIDAR data (Rₘ and vₘ) from seven or more different sample regions (N=7) in combination with equations vₘ=\vec{v}·(\vec{ra}ₘ+\vec{a}) and h=(Rₘ+dₘ)*(\vec{ra}ₘ+\vec{a})·\vec{z} to generate 14 different equations with 14 different unknown variables. The value of N can be greater than 7 since fewer than 2N equations can be generated for N different sample regions. The LIDAR data processor can solve the first system of equations for the unknown variables \vec{a}, \vec{v}, h, and dₘ. Accordingly, the LIDAR data processor can calculate the height (h), direction (\vec{a}), and velocity (\vec{v}) of the VTOL craft. The VTOL craft can include a navigation controller (not shown) that can receive all or a portion of these values from the LIDAR data processor and use these values to land and/or launch the VTOL craft. Each of the values received by the navigation controller con serve as a representative value. The navigation controller can be included in the electronics 32 or can be external to the electronics 32 and in communication with the electronics 32. Accordingly, the values of \vec{a}, \vec{v}, h, and dₘ can serve as navigation data for use in landing and/or launching the VTOL craft.

Other important variables that can be used in the landing and/or launching of a VTOL craft include the velocity in the vertical direction represented by \vec{z}. The velocity in the vertical direction (rate of vertical descent and/or ascent) can be the time derivative of h and can be represented by h′. Another important variable that can be used in the landing and/or launching of a VTOL craft is the angular velocity of the VTOL craft. The angular velocity of the VTOL craft can be the time derivative of the direction of the aircraft as represented by the time derivative of the unit vector representing the direction of the VTOL axis (\vec{a}). The time derivative of the unit vector representing the direction of the VTOL axis (\vec{a}) can be represented by \vec{a}′. Accordingly, \vec{a}′ can serve as a vector representing the rate of change in the direction of the axis of the VTOL craft. The variables h′ and \vec{a}′ are related by h′=vₘ*(\vec{ra}ₘ+\vec{a})·\vec{z}+(Rₘ+dₘ)*\vec{a}′·\vec{z}. For the first selection of sample regions, the values of vₘ, \vec{a}, \vec{v}, and dₘ were calculated during the solution of the first system of equations and are accordingly now known variables. As noted above, the values of Rₘ and vₘ are also known variables for each of the sample regions as a result of calculation by a LIDAR data generator. Further, the values of \vec{ra}ₘ and \vec{z} are also known parameters as described above. In contrast, the values of h′ and \vec{a}′ are unknown variables.

Sample regions from the first selection of sample regions can be used in a second system of equations. For instance, L different sample regions selected from the first selection of sample regions can be used in a second system of equations where the value of L is less than or equal to N. Accordingly, L different values of m can be used with the equation h′=vₘ*(\vec{ra}ₘ+\vec{a})·\vec{z}+(Rₘ+dₘ)*\vec{a}′·\vec{z} where each value of m is associated with a sample region included in the first selection of sample regions. Since one equation results from each value of m, there are L equations that can be generated for L different sample regions. The values of h′ and \vec{a}′ remain the same for each value of m and the vector \vec{a}′ provides three unknown variables that are each associated with a different one of the coordinates. As a result, in a second system of equations developed from L sample regions, the equations for h′ provide 4 unknown variables. Accordingly, the LIDAR data processor can use the LIDAR data (Rₘ and vₘ) from four or more different sample regions (L=4) in combination with h′=vₘ*(\vec{ra}ₘ+\vec{a})·\vec{z}+(Rₘ+dₘ)*\vec{a}′·\vec{z} to generate four equations with four unknown variables. The LIDAR data processor can solve the second system of equations for the unknown variables h′ and \vec{a}′. Accordingly, the LIDAR data processor can calculate the velocity (\vec{v}) of the VTOL craft in the vertical direction and the angular velocity of the VTOL craft. The navigation controller 272 can receive all, or a portion, of these values from the LIDAR data processor and use all, or a portion, of the received values to land and/or launch the VTOL craft. Accordingly, the values of h′ and \vec{a}′ can serve as navigation data for use in landing and/or launching the VTOL craft.

The navigation controller 272 can be configured to control the velocity of the VTOL craft. For instance, a navigation controller can be configured to control the speed of a VTOL craft through the control of one or more engines that provide the thrust that moves the aircraft. Examples of engines that provide thrust include, but are not limited to, rocket engines, jet engines, internal combustion engines or electrical motors that drive propellors. A navigation controller 272 can be configured to control the direction of a VTOL craft through the control of one or more guidance systems that control the direction of the VTOL craft. Examples of guidance systems include, but are not limited to, movable fins, ailerons, Vernier rockets, thrust vanes, gimbals that control the direction of thrust relative to the VTOL craft. The navigation controller 272 can be configured to control the speed and/or direction of the VTOL craft in response to the value of one or more of the navigation variables selected from the group consisting of, \vec{a} , \vec{v}, h, dₘ, h′, \vec{a} ′, Rₘ and vₘ.

The value of N can be less than the total number of sample regions in an interface pattern. For instance, a portion of the sample regions shown in FIG. 4A can be used in the first system of equations. As a result, in some instances, a portion of the values for Rₘ and vₘ generated from the same scan of the field of view are not used in the calculation of the values for \vec{a} , \vec{v}, h, dₘ, h′ and \vec{a} ′. Since values for Rₘ and vₘ can be used to determine the topography of the ground under a VTOL craft, values of Rₘ and vₘ that are not used in the first system of equations can be used as navigation data. As a result, it may be desirable for the total number of sample regions in an interface pattern to exceed the number of sample regions used to generate the equations in the first system of equations.

Suitable sample regions for use in the first selection of sample regions can be any combination of sample regions. For instance, the sample regions in the first selection of sample regions can be arranged on a line or in a non-linear configuration. Increasing the distance between sample regions in the first selection of sample regions can increase the accuracy of the r results. For instance, in some instances, the angle between the representative rays for at least one pair of sample regions in the first selection of sample regions is more than 0.2°, 5°, 10°, or 20°. In some instances, the angle between the representative rays for at least one pair of sample regions in the first selection of sample regions is more than 0.2°, 5°, 10°, or 20 ° and less than 40°, 50°, 60°.

In some instances, the LIDAR data processor can use multiple different first selection of sample regions and can calculate from each of the different first selection of sample regions a candidate value for one or more variables selected from the group consisting of \vec{a} , \vec{v}, h, dₘ, h′ and/or \vec{a} ′. Each first selection of sample regions includes different sample regions. For instance, the LIDAR data processor can calculate a candidate value of \vec{a} from each first selection of sample regions, a candidate value of \vec{v}, from each first selection of sample regions, a candidate value of h from each first selection of sample regions, a candidate value of dₘ from each first selection of sample regions, a candidate value of h′ from each first selection of sample regions, and/or a candidate value of \vec{a} ′ from each first selection of sample regions. The LIDAR data processor can combine the candidate values for one of the variables to determine a representative value for the variable. For instance, the LIDAR data processor can take an average, weighted average, median, or other combination of the candidate values for one of the variables to determine the representative value for the variable. As an example, the LIDAR data processor can take an average, weighted average, median, or other combination of the candidate values for \vec{a} ′ to calculate a representative value for the variable \vec{a}′. The VTOL navigation controller (not shown) can use the representative value for one or more of the variables to land and/or launch the VTOL craft.

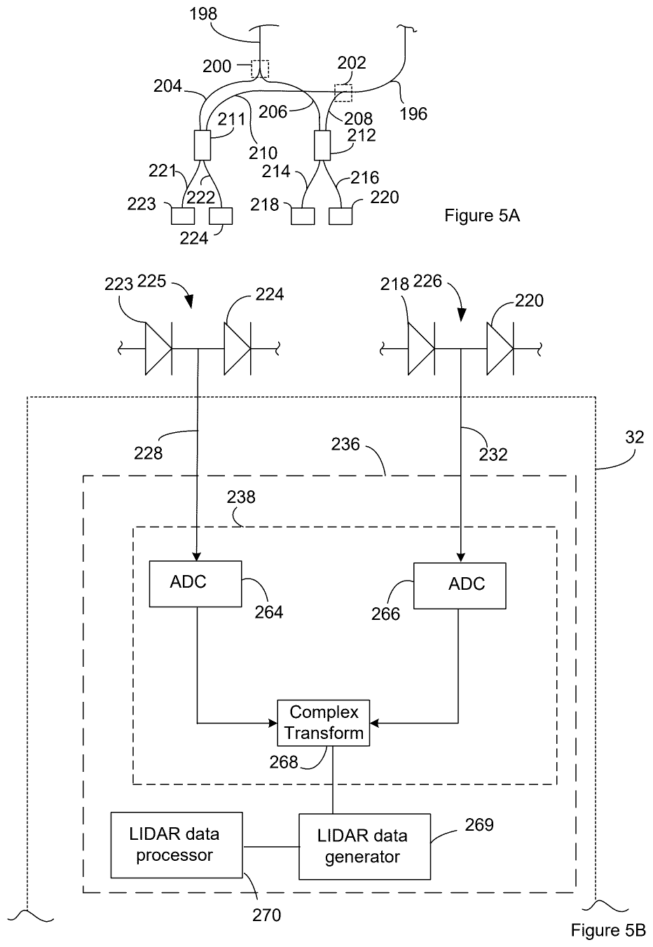

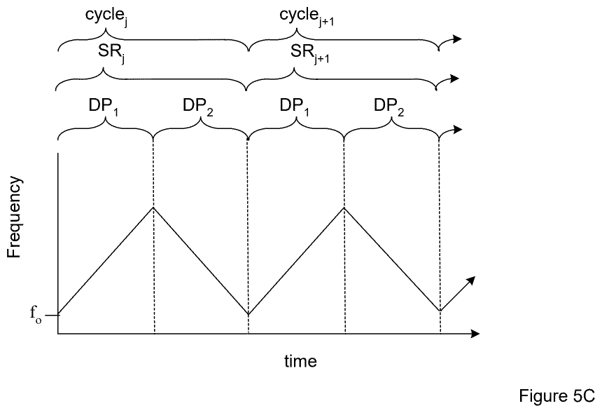

FIG. 5A through FIG. 5C illustrate an example of a suitable processing component for use as all or a fraction of the processing components 22. The processing component receives a comparative signal from a comparative waveguide 18 and a reference waveguide 42.

The processing component includes a second splitter 200 that divides the comparative signal carried on the comparative waveguide 18 onto a first comparative waveguide 204 and a second comparative waveguide 206. The first comparative waveguide 204 carries a first portion of the comparative signal to the first signal combiner 211. The second comparative waveguide 208 carries a second portion of the comparative signal to the second signal combiner 212.

The processing component includes a first splitter 202 that divides the reference signal carried on the reference waveguide 42 onto a first reference waveguide 204 and a second reference waveguide 206. The first reference waveguide 204 carries a first portion of the reference signal to the first signal combiner 211. The second reference waveguide 208 carries a second portion of the reference signal to the second signal combiner 212.

The second signal combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second signal combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second signal combiner 212 splits the second composite signal such that the portion of the comparative signal (i.e. the portion of the second portion of the comparative signal) included in the first portion of the second composite signal is phase shifted by 180 ° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second signal combiner 212 splits the second composite signal such that the portion of the reference signal (i.e. the portion of the second portion of the reference signal) in the first portion of the second composite signal is phase shifted by 180 ° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first signal combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The first signal combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the first signal combiner 211 splits the first composite signal such that the portion of the comparative signal (i.e. the portion of the first portion of the comparative signal) included in the first portion of the composite signal is phase shifted by 180 0 relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the first signal combiner 211 splits the composite signal such that the portion of the reference signal (i.e. the portion of the first portion of the reference signal) in the first portion of the composite signal is phase shifted by 180 ° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second signal combiner 212 splits the second composite signal such that the portion of the comparative signal in the first portion of the second composite signal is phase shifted by 180 ° relative to the portion of the comparative signal in the second portion of the second composite signal, the first signal combiner 211 also splits the composite signal such that the portion of the comparative signal in the first portion of the composite signal is phase shifted by 180 ° relative to the portion of the comparative signal in the second portion of the composite signal. When the second signal combiner 212 splits the second composite signal such that the portion of the reference signal in the first portion of the second composite signal is phase shifted by 180 ° relative to the portion of the reference signal in the second portion of the second composite signal, the first signal combiner 211 also splits the composite signal such that the portion of the reference signal in the first portion of the composite signal is phase shifted by 180 ° relative to the portion of the reference signal in the second portion of the composite signal.

Suitable light signal combiners that can serve as the first signal combiner 211 and/or the second signal combiner 212 include, but are not limited to, a Multi-Mode Interference (MMI) device such as a 2×2 MMI device. Other suitable light signal combiners include, but are not limited to, adiabatic splitters, and directional couplers. In some instances, the functions of the light signal combiner are performed by more than one optical component or a combination of optical components.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function, and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

In the LIDAR system disclosed in the context of FIG. 3A and FIG. 5A, the composite signals, the comparative signals, the LIDAR input signals, the system return signals, the system output signals, and the LIDAR output signals include light from the outgoing LIDAR signal. In the LIDAR system disclosed in the context of FIG. 3A and FIG. 5A, the composite signals, the comparative signals, the LIDAR input signals, the system return signals, and the system output signals include light from the LIDAR output signals. In the LIDAR system disclosed in the context of FIG. 3A and FIG. 5A, the composite signals, the comparative signals, the LIDAR input signals, and the system return signals include light from the system output signals. In the LIDAR system disclosed in the context of FIG. 3A and FIG. 5A, the composite signals, the comparative signals, and the LIDAR input signals include light from the system return signals. In the LIDAR system disclosed in the context of FIG. 3A and FIG. 5A, the composite signals, and the comparative signals, include light from the LIDAR input signals. In the LIDAR system disclosed in the context of FIG. 3A and FIG. 5A, the composite signals include light from the comparative signals.

The first light sensor 223 and the second light sensor 224 can be connected as a balanced detector and the first auxiliary light sensor 218 and the second auxiliary light sensor 220 can also be connected as a balanced detector. For instance, FIG. 5B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 5B are included on the LIDAR chip. In some instances, the components illustrated in the schematic of FIG. 5B are distributed between the LIDAR chip and electronics located off of the LIDAR chip.

The electronics connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform, and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics include a data processor 236 configured to generate LIDAR data for the sample regions. The data processor 236 includes a mathematical transformer 238 configured to perform a mathematical transform on the first data signal and the second data signal. For instance, the mathematical transform can be a complex Fourier transform with the first data signal and the second data signal as inputs. Since the first data signal is an in-phase component and the second data signal its quadrature component, the first data signal and the second data signal together act as a complex data signal where the first data signal is the real component and the second data signal is the imaginary component of the input.

The mathematical transformer 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The mathematical transformer 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The mathematical transformer 238 includes a transform component 268 that receives the complex data signal. For instance, the transform component 268 receives the first digital data signal from the first Analog-to-Digital Converter (ADC) 264 as an input and also receives the second digital data signal from the second Analog-to-Digital Converter (ADC) 266 as an input. The transform component 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of LIDAR input signal relative to the LIDAR output signal that is caused by the radial velocity between the reflecting object and the LIDAR chip.

The mathematical transformer 238 includes can include a peak finder (not shown) configured to identify peaks in the output of the mathematical transformer 238 includes. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal and accordingly of the data signal.

The data processor 236 includes a LIDAR data generator 269 configured to receive the output from the transform component 268. For instance, the LIDAR data generator 269 can receive the beat frequency from the transform component 268. The LIDAR data generator 269 treats the frequency at the identified peak as the beat frequency of the comparative signal beating against all or a portion of a reference signal. The LIDAR data generator 269 can use the received beat frequencies in combination with the frequency pattern of the LIDAR output signals and/or the system output signals to generate LIDAR data results (distance and/or radial velocity between the reflecting object and the LIDAR chip or LIDAR system).

As noted above, the light source controller can adjust the frequency of the outgoing LIDAR signals so as to provide the outgoing LIDAR signal, and the light signals that include light from the outgoing LIDAR signal, with a desired frequency versus time pattern. FIG. 5C shows an example of a relationship between an example of a frequency versus time pattern for a system output signal with time, cycles, data periods, sample regions, and chirp periods. The base frequency of the system output signal (fₒ) can be the lowest frequency of the system output signal during a chirp period.

FIG. 5C shows frequency versus time for a sequence of two cycles labeled cycleⱼ and cycleⱼ₊₁ where j represents a cycle index. In some instances, the frequency versus time pattern is repeated in each cycle as shown in FIG. 5C. The illustrated cycles do not include re-location periods and/or re-location periods are not located between cycles. As a result, FIG. 5C illustrates the results for a continuous scan.

Each cycle includes K chirp periods that are each associated with a period index k and are labeled DPₖ. In the example of FIG. 5C, each cycle includes two chirp periods labeled DPₖ with k=1 and 2. In some instances, the frequency versus time pattern is the same for the chirp periods that correspond to each other in different cycles as is shown in FIG. 5C. Corresponding chirp periods are chirp periods with the same period index. As a result, each chirp period DP₁ can be considered corresponding chirp periods and the associated frequency versus time patterns are the same in FIG. 5C. At the end of a cycle, the electronics return the frequency to the same frequency level at which it started the previous cycle.

During the chirp period DP₁, and the chirp period DP₂, the frequency of the system output signal is linearly chirped. For instance, a feedback loop can be configured to operate the light source such that the frequency of the system output signal changes at a linear rate a during the chirp periods DP₁ and DP₂. The direction of the frequency change during the chirp period DP₁ is the opposite of the direction of the frequency change during the chirp period DP₂.

The frequency output from the Complex Fourier transform represents the beat frequency of the composite signals that each includes a comparative signal beating against a reference signal. The beat frequencies (f_{LDP}) from two or more different chirp periods can be combined to generate the LIDAR data. For instance, the beat frequency determined from DP₁ in FIG. 5C can be combined with the beat frequency determined from DP₂ in FIG. 5C to determine the LIDAR data. As an example, the following equation applies during a chirp period where electronics increase the frequency of the outgoing LIDAR signal during the chirp period such as occurs in chirp period DP₁ of FIG. 5C: f_{ub}=−f_{d}+aτ where f_{ub} is the frequency provided by the transform component 268 (f_{LDP} determined from DP₁ in this case), f_{d} represents the Doppler shift (f_{d}=2νf_{c}/c) where fc represents the optical frequency (fₒ), τ is the roundtrip time (time between the system output signal exiting from the LIDAR system and the system return signal returning to the LIDAR system), c represents the speed of light, v is the radial velocity between the reflecting object and the LIDAR system where the direction from the reflecting object toward the LIDAR system is assumed to be the positive direction, c is the speed of light. The following equation applies during a chirp period where electronics decrease the frequency of the outgoing LIDAR signal such as occurs in chirp period DP₂ of FIG. 5C: f_{db}=−f_{d}−aτ where f_{db} is a frequency provided by the transform component 268 (f_{i, LDP} determined from DP₂ in this case). In these two equations, f_{d} and τ are unknowns. These two equations can be solved for the two unknowns. The LIDAR data generator can calculate the radial velocity for the sample region from the Doppler shift (v=c*f_{d}/(2f_{c})) and/or the separation distance for that sample region can be quantified from c*τ/2. The radial velocity calculated for sample region SRₘ can serve as the magnitude of the velocity of the VTOL craft in the direction \vec{r}ₘ described as vₘ above. The separation distance calculated for sample region SRₘ can serve as the distance between the LIDAR system and the ground for in the direction \vec{r}ₘ described as Rₘ above.

Each of the sample regions that is illuminated during a combination of chirp periods used to generate the LIDAR data for that sample region is labeled SRₘ in FIG. 5C where m represents a sample region index. In the example of FIG. 5C, each of the different sample regions is illuminated during a different one of the cycles. As a result, in this example, the sample region index m can be equal to the cycle index. However, other configurations are possible.

In some instances, more than one object is present in a sample region. In some instances when more than one object is present in a sample region, the transform may output more than one frequency where each frequency is associated with a different object. The frequencies that result from the same object in different chirp periods of the same cycle can be considered corresponding frequency pairs. LIDAR data can be generated for each corresponding frequency pair output by the transform. As a result, separate LIDAR data can be generated for each of the objects in a sample region.

In some instances, the LIDAR data generator 269 stores the LIDAR data results (Rₘ and/or vₘ) from different sample regions in a storage device (not shown) included in the data processor 236. Accordingly, the LIDAR data generator 269 can store the known variables Rₘ and/or vₘ in the storage device (not shown). The known parameters for the first system of equations and the second system of equations can also be stored in the memory device. Suitable memory devices include, but are not limited to, DRAM and SRAM.

The data processor 236 includes a LIDAR data processor 270 configured to process the data from multiple different sample regions so as to calculate navigation data for the VTOL craft. The LIDAR data processor 270 can access the known variables (Rₘ and/or vₘ) from the storage device (not shown). The known parameters for the first system of equations and the second system of equations (\vec{z} and/or \vec{ra}ₘ) can also be stored in the memory device. Suitable memory devices include, but are not limited to, DRAM and SRAM.

The LIDAR data processor 270 can access the known parameters and known variables stored in the memory device and use them to generate the equations for the first system or equations. The LIDAR data processor 270 can solve the first set of equations for the values of the unknown variables \vec{a}, \vec{v}, h, and dₘ. Accordingly, the LIDAR data processor 270 can calculate the height (h), direction (\vec{a}), and velocity (\vec{v}) of the VTOL craft from the first set of equations. The LIDAR data processor 270 can use the calculated values of one, more than one, all, or a portion of the variables selected from the group consisting \vec{a}, \vec{v}, h, and dₘ in combination with the known parameters and known variables stored in the memory device to generate the generate the equations for the second system or equations. The LIDAR data processor 270 can solve the second set of equations for the values of the unknown variables (h′ and/or \vec{a}′). Accordingly, the LIDAR data processor 270 can calculate the values of the velocity of the VTOL craft in the vertical direction represented by \vec{z} and represented by h′ and the vector representing the rate of change in the direction of the axis of the VTOL craft as represented by the angular velocity of the VTOL craft (\vec{a}′) .

The LIDAR data processor 270 can solve the systems of equations using algorithms for solving non-linear equation systems such as the Levenberg-Marquardt algorithm, the Gauss-Newton method, or the gradient descent method. Although the LIDAR data processor 270 is illustrated as being included in the electronics 32, the LIDAR data processor 270 can be included in the VTOL craft external to the electronics 32 and in electrical communication with the electronics 32.

The navigation controller 272 can receive one, more than one, all, or a portion of the navigation variable values selected from the group consisting of the height of the VTOL craft (h), the direction of the axis of the VTOL craft (\vec{a}), velocity (\vec{v}) of the VTOL craft, velocity of the VTOL craft in the vertical direction (\vec{z}) as represented by h′ and the rate of change in the direction of the axis of the VTOL craft (\vec{a} ′), the value of Rₘ for all or a portion of the sample regions, the values of vₘ for all or a portion of the sample regions, and the representative direction (\vec{r}ₘ) for all or a portion of the sample regions. The navigation controller 272 can receive all or a portion of the navigation variable values from the LIDAR data processor 270 and/or the storage device. The navigation controller 272 can be included in the LIDAR system or can be included in the VTOL craft external to the LIDAR system.

The navigation controller 272 can use all or a portion of the navigation variable values to in landing and/or launching the VTOL craft. The navigation controller can be configured to control the velocity of the VTOL craft in response to one or more variables in the navigation data selected from the group consisting of \vec{a}, \vec{v}, h, dₘ, h′, \vec{a}′, Rₘ and vₘ. As an example, the LIDAR system can perform multiple scans of the field of view during the takeoff and/or landing of the VTOL craft. As a result, multiple values of one or more variables in the navigation data selected from the group consisting of \vec{a}, \vec{v}, h, dₘ, h′, \vec{a}′, Rₘ and vₘ can be generated. The navigation controller can use the values of \vec{a} in a feedback loop to control the one or more navigation components such that the VTOL craft has the desired direction, \vec{a}, during the takeoff and/or landing of the VTOL craft. In some instances, the navigation controller calculates the desired direction, \vec{a}, during the takeoff and/or landing of the VTOL from the topography indicated by the values of Rₘ and vₘ. As another example, the navigation controller can use the values of h′ in a feedback loop to control the one or more navigation components such that the VTOL craft has the desired rate of vertical descent and/or ascent, h′, during the takeoff and/or landing of the VTOL craft. As another example, the navigation controller can use the values of \vec{a}′ in a feedback loop to control the one or more navigation components such that the VTOL craft minimizes the angular rotation (\vec{a}′) or provides the VTOL craft with the desired rate of angular rotation (\vec{a}′) during the takeoff and/or landing of the VTOL craft. As another example, the navigation controller can use the values of \vec{v} in a feedback loop to control the one or more navigation components such that the VTOL craft has a desired velocity of the VTOL craft (\vec{v}) during the takeoff and/or landing of the VTOL craft. In some instances, the desired velocity of the VTOL craft (\vec{v}) during the takeoff and/or landing of the VTOL craft changes as a function of time according to a velocity profile. As a result, the desired velocity of the VTOL craft (\vec{v}) during the takeoff and/or landing can change during the takeoff and/or landing of the VTOL craft so as to provide the during the VTOL craft with a velocity versus time that matches or approximates the velocity profile.

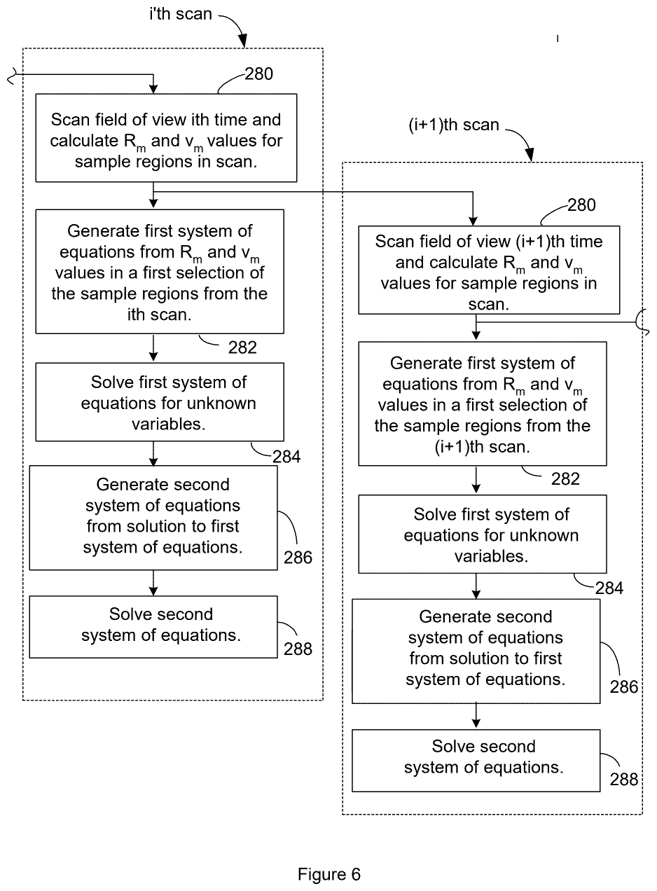

FIG. 6 is a flow diagram illustrating one possible example of the relationship between operations performed by a LIDAR data generator 269 and the operations performed by a LIDAR data processor 270. Scans of the LIDAR systems field of view can be conducted in series. For instance, a system output signal can be scanned through the interface patten of FIG. 4A multiple times in series. As a result, the field of view can be scanned multiple times in series during operation of a VTOL craft. As an example, the field of view can be scanned multiple times in series during the ascent of a VTOL craft associated with takeoff of the VTOL craft and/or during the descent of a VTOL craft associated with landing of the VTOL craft. Each scan in the series can be associated with a scan index i. FIG. 6 illustrates operations performed by a LIDAR data generator 269 and the operations performed by a LIDAR data processor 270 in response to sequential scans of the field of view. For instance, FIG. 6 illustrates the operations associated with an ith scan of the field of view followed by an (i+1)th scan of the field of view where the ith scan the (i+1)th scan are performed in series.

At process block 280 of the ith scan, the light source controller 62 operates the light source and the scan controller 60 operates the one or more beam scanners so as to scan the system output signal through the field of view. The LIDAR data generator 269 uses the results of the ith scan to calculate the values of Rₘ and vₘ for the sample regions in the ith scan. At process block 282 of the ith scan, the LIDAR data processor 270 generates the equations for the first system of equations from the values of Rₘ and vₘ calculated from the ith scan. At process block 282 of the ith scan, the LIDAR data processor 270 generates the equations for the first system of equations from the values of Rₘ and vₘ calculated from the ith scan. At process block 284 of the ith scan, the LIDAR data processor 270 solves the first system of equations generated at process block 282 for the unknown variables. At process block 286 of the ith scan, the LIDAR data processor 270 generates the equations for the second system of equations from the values of Rₘ and vₘ calculated from the ith scan and from the solutions generation at process block 284. At process block 2884 of the ith scan, the LIDAR data processor 270 solves the second system of equations generated at process block 286 for the unknown variables. As a result, the navigation data that result from the solutions at process block 284 (\vec{a}, \vec{v}, h, and dₘ) and process block 286 (h′ and \vec{a} ′) of the ith scan are results for the ith scan of the field of view and are accordingly associated with the ith scan of the field of view. Additionally, the values of Rₘ and vₘ generated at process block 280 of the ith scan are associated with the ith scan of the field of view.

The process block 280 through process block 288 are repeated for the (i+2)th scan. As a result, the navigation data that result from the solutions at process block 284 (\vec{a}, \vec{v}, h, and dₘ) and process block 286 (h′ and \vec{a}′) of the (i+1)th scan are results for the (i+1)th scan of the field of view and are accordingly associated with the (i+1)th scan of the field of view. Additionally, the values of Rₘ and vₘ generated at process block 280 of the (i+1)th scan are associated with the (i+1)th scan of the field of view. As a result, each of the serial scans produces new navigation data. Accordingly, serially scanning the field of view during the ascent and/or descent of a VTOL craft provides navigation data that is being updated during the ascent and/or descent of the VTOL craft. Since the features of the ground that are within the field of view can change during the ascent and/or descent of the VTOL craft, the conditions of the VTOL craft such as direction and/or velocity can change during the ascent and/or descent of the VTOL craft, and/or conditions outside of the VTOL craft such as windspeed can change during the ascent and/or descent of the VTOL craft, the updating of the field of view gives the navigation controller an opportunity to respond to changing conditions during the ascent and/or descent of the VTOL craft.

FIG. 6 illustrates that all or a portion of the operations associated with different scans of the field of view can be performed in series of in parallel. For instance, a subsequent scan, such as the (i+th) scan, of the field of view and/or the generation of the Rₘ and vₘ values from a subsequent scan, such as the (i+th) scan, can be performed in parallel with the generation and/or solution of the systems of equations from an earlier scan, such as the (i+th) scan.

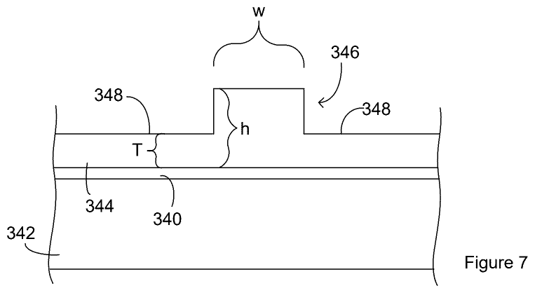

FIG. 7 is a cross section of a portion of a LIDAR chip that includes a waveguide construction that is suitable for use in LIDAR chips constructed from silicon-on-insulator wafers. A silicon-on-insulator wafer has a buried oxide layer 340 between a silicon substrate 342 and a silicon light-transmitting medium. In FIG. 8, a ridge 346 of the light-transmitting medium extends away from slab regions 348 of the light-transmitting medium. The light signals are constrained between the top of the ridge 346 and the buried oxide layer 340.

The dimensions of the ridge waveguide are labeled in FIG. 7. For instance, the ridge has a width labeled w and a height labeled h. The thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction disclosed in the context of FIG. 8 is suitable for all or a portion of the waveguides on LIDAR chips constructed according to FIG. 1A through FIG. 1B.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first auxiliary light sensor 218, the second auxiliary light sensor 220, the first light sensor 223, and the second light sensor 224.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10 2012; U.S. Pat. No. 8,242,432, issued Aug. 14 2012; and U.S. Pat. No. 6,108,472, issued on Aug. 22, 2000 each of which is incorporated herein in its entirety. The use of light sensors that are integrated with the chip are suitable for all or a portion of the light sensors selected from the group consisting of the auxiliary light sensor 218, the second auxiliary light sensor 220, the first light sensor 223, and the second light sensor 224.

The light source 4 that is interfaced with the utility waveguide 12 can be a laser chip that is separate from the LIDAR chip and then attached to the LIDAR chip. For instance, the light source 4 can be a laser chip that is attached to the chip using a flip-chip arrangement. Use of flip-chip arrangements is suitable when the light source 4 is to be interfaced with a ridge waveguide on a chip constructed from silicon-on-insulator wafer. Alternately, the utility waveguide 12 can include an optical grating (not shown), such as a Bragg grating, that acts as a reflector for an external cavity laser. In these instances, the light source 4 can include a gain element that is separate from the LIDAR chip and then attached to the LIDAR chip in a flip-chip arrangement. Examples of suitable interfaces between flip-chip gain elements and ridge waveguides on chips constructed from silicon-on-insulator wafer can be found in U.S. Pat. No. 9,705,278, issued on Jul. 11, 2017, and in U.S. Pat. No. 5,991,484 issued on November 23 1999; each of which is incorporated herein in its entirety. When the light source 4 is a gain element or laser chip, the electronics 32 can change the frequency of the outgoing LIDAR signal by changing the level of electrical current applied to through the gain element or laser cavity.

Suitable electronics 32 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of a LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable data processor 236 executes the attributed functions using firmware, hardware, or software or a combination thereof. An example of a suitable scan controller 60 executes the attributed functions using firmware, hardware, or software or a combination thereof. An example of a suitable light source controller 62 executes the attributed functions using firmware, hardware, or software or a combination thereof. In some instances, all or a portion of the components selected from the group consisting of the mathematical transformer 238, the LIDAR data generator 269, the LIDAR data processor 270, and the navigation controller executes the attributed functions using firmware, hardware, or software or a combination thereof.

The above LIDAR systems include multiple optical components such as a LIDAR chip, LIDAR adapters, light source, light sensors, waveguides, and amplifiers. In some instances, the LIDAR systems include one or more passive optical components in addition to the illustrated optical components or as an alternative to the illustrated optical components. The passive optical components can be solid-state components that exclude moving parts. Suitable passive optical components include, but are not limited to, lenses, mirrors, optical gratings, reflecting surfaces, splitters, demulitplexers, multiplexers, polarizers, polarization splitters, and polarization rotators. In some instances, the LIDAR systems include one or more active optical components in addition to the illustrated optical components or as an alternative to the illustrated optical components. Suitable active optical components include, but are not limited to, optical switches, phase tuners, attenuators, steerable mirrors, steerable lenses, tunable demulitplexers, tunable multiplexers.

Although the operation of the LIDAR system and VTOL craft are described in the context of the ascent, descent, takeoff and landing of the VTOL craft, the above operation of the LIDAR system and VTOL craft can be employed during other stages of operation. For instance, the described operation of the LIDAR system and VTOL craft can be executed during cruising of the VTOL craft.

Although the above systems are disclosed in the context of VTOL craft, the above systems can be employed in other aerospace craft. For instance, aerospace craft can include and/or operate one or more of the disclosed LIDAR systems. Examples of suitable aerospace craft include, but are not limited to, Horizontal Takeoff and Landing craft (HTOL craft), such as aircraft and UAVs (Uncrewed Aerial Vehicles). Other examples of suitable aerospace craft include, but are not limited to, craft that concurrently, separately, or serially make use of Horizontal Takeoff and Landing (HTOL) and Vertical Takeoff and Landing (VTOL craft) approaches, such as UAVs, space planes, re-usable rockets, and planetary landers.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
an aerospace craft;
a LIDAR system configured to calculate LIDAR data results for multiple different sample regions,
each LIDAR data result indicating a distance and/or radial velocity between the aerospace craft and a surface of the ground in one of the sample regions; and
the aerospace craft including a LIDAR data processor configured to calculate an angular velocity of the aerospace craft from the LIDAR data results.

2. The system of claim 1, wherein the aerospace craft is a Vertical Takeoff and Landing craft (VTOL craft).

3. The system of claim 2, wherein the angular velocity is a rate of change of direction of an axis of the Vertical Takeoff and Landing craft (VTOL craft).

4. The system of claim 3, wherein the axis is perpendicular to a surface that is flat and horizontal when the VTOL craft has landed on the surface.

5. The system of claim 2, wherein the Vertical Takeoff and Landing craft (VTOL craft) includes a navigation controller configured to adjust a speed and/or direction of the Vertical Takeoff and Landing craft (VTOL craft) in response to a value of the angular velocity.

6. The system of claim 5, wherein the navigation controller is configured to use multiple values of the angular velocity in a feedback loop so as to minimize the angular rotation of the Vertical Takeoff and Landing craft (VTOL craft).

7. The system of claim 5, wherein the navigation controller is configured to use multiple values of the angular velocity in a feedback loop so as to maintain the angular rotation of the Vertical Takeoff and Landing craft (VTOL craft) at a desired level.

8. The system of claim 1, wherein the LIDAR data processor is configured to calculate the angular velocity from a system of equations that includes the equation: h′=vₘ*(\vec{ra}ₘ+\vec{a})·\vec{z}+(Rₘ+dₘ)*\vec{a}′·\vec{z} where h′ represents a velocity in the vertical direction, vₘ represents the radial velocity from the LIDAR data results for one of the sample regions associated with a sample region index m, \vec{ra}ₘ represents a direction of the sample regions associated with a sample region index m relative to the axis, Rₘ represents the distance from the LIDAR data results for the sample region associated with the sample region index m, \vec{z} represents a direction of a coordinate system axis, \vec{a} represents the direction of the axis measured relative to the coordinate system, and dₘ represents an unknown distance.

9. The system of claim 8, wherein the LIDAR data processor is configured to calculate a value of h′ from the equation
h′=vₘ*(\vec{ra}ₘ+\vec{a})·\vec{z}+(Rₘ+dₘ)*\vec{a}′·\vec{z}.

10. The system of claim 8, wherein the LIDAR data processor is configured to calculate values of vₘ, \vec{a}, \vec{v}, and dₘ from a second system of equations.

11. The system of claim 8, wherein the aerospace craft includes a navigation controller configured to adjust a speed and/or direction of the aerospace craft in response to a value of the angular velocity.

12. The system of claim 11, wherein the navigation controller is configured to use multiple values of the angular velocity in a feedback loop so as to minimize the angular rotation of the aerospace craft.

13. The system of claim 11, wherein the navigation controller is configured to use multiple values of the angular velocity in a feedback loop so as to maintain the angular rotation of the aerospace craft at a desired level.

14. The system of claim 1, wherein the LIDAR system is configured to output a system output signal that travels away from the LIDAR system,
the LIDAR system being configured to scan the system output signal in two dimensions,
the LIDAR system being configured to use a system return signal to calculate the LIDAR data results, and
the system return signal including light from the system output signal that has been reflected by a surface of the ground below the aerospace craft.

15. The system of claim 1, wherein the LIDAR system is configured to scan the system output signal in two dimensions.

16. A system, comprising:
Vertical Takeoff and Landing craft (VTOL craft); and
a LIDAR system configured to output a system output signal that travels away from the LIDAR system,
the LIDAR system being configured to scan the system output signal in two dimensions, and
the LIDAR system configured to use a system return signal to calculate a distance and/or radial velocity between the ground and the Vertical Takeoff and Landing craft (VTOL craft),
the system return signal including light from the system output signal that has been reflected by a surface of the ground below the Vertical Takeoff and Landing craft (VTOL craft).
